(19) United States
(12) Patent Application Publication
(10) Pub. No.: US 2026/0261430 A1
(43) Pub. Date: Sep. 3, 2026

(54) DECENTRALIZED AI AGENT NETWORK SYSTEM BUILT UPON BLOCKCHAIN-BASED WEB3 AI-ID AND WEB3 AI-CONTRACT FOR VERIFIABLE CONFIDENTIAL AI AGENT COMPUTING

(71) Applicant: BLOCKCHAIN LABS INC., Seoul (KR)

(72) Inventors: Yong Tae KIM, Seoul (KR); Byung Wan LIM, Seoul (KR); Jong Hoon PARK, Hanam-si (KR)

(73) Assignee: BLOCKCHAIN LABS INC., Seoul (KR)

(21) Appl. No.: 19/303,959

(22) Filed: Aug. 19, 2025

Related U.S. Application Data
(60) Provisional application No. 63/764,594, filed on Feb. 28, 2025.

(30) Foreign Application Priority Data
Aug. 5, 2025 (KR) 10-2025-0107438

(51) Int. Cl. H04L 9/32; H04L 9/00; H04L 9/30

(52) U.S. Cl. CPC H04L 9/3247; H04L 9/3073; H04L 9/50

(57) ABSTRACT

There is disclosed a first web3ai agent, having: a memory that stores a first web3ai-ID and a private key, a communication interface that communicates with a blockchain network on which a first web3ai contract is registered, and a processor that generates a pair of a processor private key and a processor public key, transmits the processor public key to an outside of the processor, executes code corresponding to an AI agent service specified in the first web3ai contract, obtains a code hash value and a state root value, generates a first electronic signature based on the processor private key, and transmits, to the blockchain network, a registration request for the first electronic signature including a second electronic signature generated based on the first electronic signature and the private key corresponding to the first web3ai-ID to register the first electronic signature in the first web3ai contract.

### CROSS-REFERENCE TO RELATED APPLICATION

This application is based on and claims priority to U.S. Provisional Patent Application No. 63/764,594 filed on Feb. 28, 2025, and Korean Patent Application No. 10-2025-0107438 filed on Aug. 5, 2025, and all the benefits accruing therefrom under 35 U.S.C. § 119, the contents of which are incorporated by reference in their entirety.

### BACKGROUND

Embodiments disclosed in this document relate to AI agent technology, blockchain technology, and Web 3.0 technology.

### SUMMARY

Software before the artificial intelligence era was implemented to operate on Web 2.0 systems centered around central servers operated by service providers and client applications. Meanwhile, with the continuous development and performance improvement of artificial intelligence technology, the need for AI agent models that may autonomously assess situations and take appropriate actions without direct user intervention or instruction has emerged. When AI agents become widespread, individual users and existing web service providers will each possess autonomously operating AI agents. Such an environment is difficult to create under the existing central server-based cloud computing SaaS paradigm.

When AI agents are implemented by specific companies, personal data or AI agents become the property of the specific companies, which may infringe upon sovereignty over personal data. Therefore, there is a need to provide a blockchain-based network protocol that may implement AI agents that operate autonomously in a decentralized manner without being owned by any specific platform. By utilizing blockchain-based DID (Decentralized Identifier) web standard technology for AI agent IDs, users may maintain sovereignty over their IDs and data for AI agents by using blockchain-based DIDs generated on user devices without depending on specific companies' central server systems. Furthermore, even when AI agents operate autonomously in a decentralized manner, identity information may be verified based on blockchain technology, enabling AI agents to communicate with each other in a trustworthy environment.

Large amounts of personal data are required to enhance AI agent performance. Therefore, serious side effects such as leakage and infringement of private information may occur while processing large amounts of personal data. For example, server devices must be used to process huge amounts of data, and there may be a risk of data leakage during communication with server devices. Therefore, by providing mechanisms to prevent personal data leakage in the protocol, there is a need to provide AI agents that may manage and process large amounts of personal data without risk of data leakage.

Additionally, to enable AI agents to automatically perform various tasks, it is necessary to unify interfaces among service providers of services for AI agents (hereinafter, AI agent services). When service providers use different interfaces, the scalability of AI agent services and furthermore the scalability of the AI agent ecosystem is limited. Accordingly, there is a need to provide a protocol with scalability by publicly disclosing AI agent service interfaces based on blockchain and inducing reuse of publicly disclosed AI agent service interfaces among different AI agents. Hereinafter, AI agents implemented on the protocol disclosed through the present invention are referred to as web3ai agents.

A first web3ai agent, comprising: a memory storing a first web3ai-ID corresponding to the first web3ai agent and a private key corresponding to the first web3ai-ID, a communication interface configured to communicate with a blockchain network on which a first web3ai contract corresponding to the first web3ai agent is registered, and at least one processor, wherein the at least one processor is configured to: generate a pair of a processor private key and a processor public key, transmit the processor public key to an outside of the at least one processor, execute code corresponding to at least one AI agent service specified in the first web3ai contract, obtain a code hash value corresponding to the executed code, obtain a state root value for personal data processed through the executed code, generate a first electronic signature for the code hash value and the state root value based on the processor private key and transmit, to the blockchain network, a registration request for the first electronic signature including a second electronic signature generated based on the first electronic signature and the private key corresponding to the first web3ai-ID to register the first electronic signature in the first web3ai contract

According to a protocol disclosed in this document, web3ai agents may verify identity information through a blockchain network and autonomously perform communication based on mutual trust relationships. Additionally, based on AI agent service interfaces published through the blockchain network, AI agent services may be provided based on unified interfaces and have scalability on the protocol.

A web3ai agent according to an embodiment disclosed in this document may provide personalized services based on vast amounts of personal data while guaranteeing to users that there is no risk of personal data leakage. In addition to this, various effects that can be directly or indirectly identified through this document may be provided.

### BRIEF DESCRIPTION OF THE DRAWINGS

FIG. 1 is a diagram for explaining a protocol provided through a plurality of web3ai agents and a blockchain network according to an embodiment.

FIG. 2 is a block diagram of a web3ai agent according to an embodiment.

FIG. 3 is a diagram for explaining a method of preventing exposure of personal data processed on the web3ai agent according to an embodiment.

FIG. 4 is a signal flow diagram of a method for updating the TEE/ZK rollup contract and verifying TEE electronic signatures according to an embodiment.

FIG. 5 is a signal flow diagram of a method for creating and utilizing AI agent service interfaces on a protocol according to an embodiment.

FIG. 6 is an example of item recommendation services provided by a plurality of e-commerce service web3ai agents according to an embodiment.

FIG. 7 is an example of an interface for item recommendation services associated with e-commerce services.

With respect to the description of the drawings, the same or similar reference signs may be used for the same or similar elements.

### DETAILED DESCRIPTION OF EMBODIMENTS

Hereinafter, various embodiments of the present disclosure will be described with reference to the accompanying drawings. However, this is not intended to limit the present disclosure to the specific embodiments, and it is to be construed to include various modifications, equivalents, and/or alternatives of embodiments of the present disclosure.

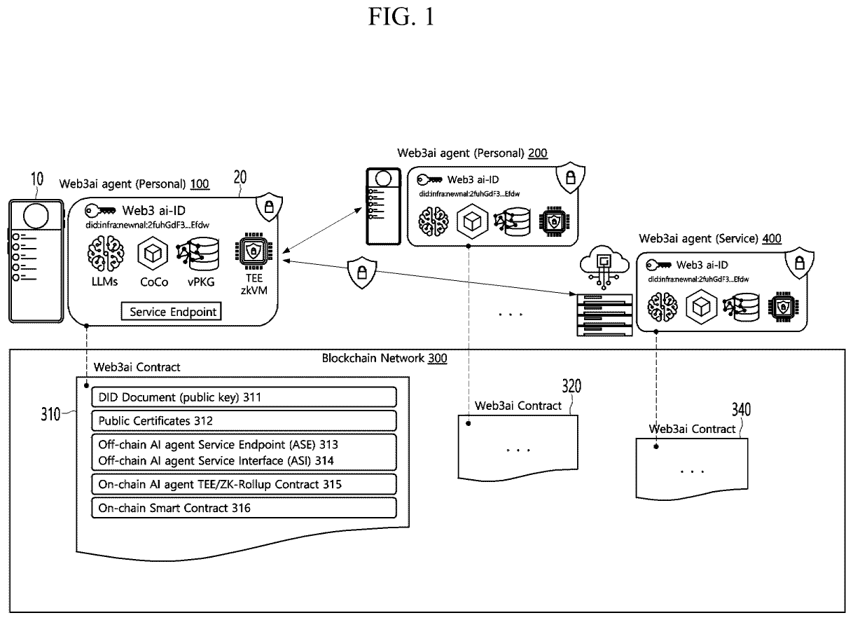

FIG. 1 is a diagram for explaining a protocol provided through a plurality of web3ai agents (100, 200, 400) and a blockchain network (300) according to an embodiment. Referring to FIG. 1, personal web3ai agents (100, 200) and a service web3ai agent (400) are illustrated as examples for explaining the plurality of web3ai agents (100, 200, 400). The plurality of web3ai agents (100, 200, 400) may be classified into personal web3ai agents (100, 200) and service web3ai agent (400) depending on whether the web3ai agent owner (operator) is an individual or a service company. The personal web3ai agents (100, 200) and the service web3ai agent (400) may have technically identical configurations and perform identical functions, differing only in their roles in the protocol.

In the protocol according to an embodiment of the present invention, web3ai agents may communicate with other web3ai agents published on other internet networks and operate cooperatively. The plurality of web3ai agents (100, 200, 400) in FIG. 1 may communicate with each other and operate together through network connections.

In the protocol, each of the plurality of web3ai agents (100, 200, 400) may be identified by a web3ai-ID. Each of the web3ai agents (100, 200, 400) may have one web3ai-ID. The web3ai-ID may be understood as a unique identifier of a web3ai agent in the protocol.

A web3ai-ID according to an embodiment may be implemented as a blockchain-based DID (Decentralized Identifier). The plurality of web3ai agents (100, 200, 400) may directly generate web3ai-IDs. The plurality of web3ai agents (100, 200, 400) may generate a pair of public key/private key corresponding to each web3ai-ID. The pair of public key/private key may function as an account on the blockchain network (300). A web3ai-ID according to an embodiment may be the public key or may be a separate DID corresponding to the public key.

The plurality of web3ai agents (100, 200, 400) may generate electronic signatures using the private key and may self-authenticate ownership of the web3ai-ID based on the electronic signature. Additionally, the plurality of web3ai agents (100, 200, 400) may create communication channels with guaranteed confidentiality with other web3ai agents through data encryption using the private key.

Hereinafter, as an example of the plurality of web3ai agents (100, 200, 400), web3ai agent (100) will be described. The description of web3ai agent (100) may be equally applied to other web3ai agents (200, 400).

The web3ai agent (100) may create a web3ai contract (310) corresponding to its web3ai-ID on the blockchain network (300). The web3ai agent (100) may generate the web3ai-ID and the private key and public key corresponding to the web3ai-ID, and transmit a web3ai contract creation request corresponding to the web3ai-ID to the blockchain network (300). The web3ai contract creation request may include the web3ai-ID and an electronic signature generated based on the private key corresponding to the web3ai-ID. A web3ai contract corresponding to the web3ai is created on the blockchain network (300). The web3ai agent (100) may be made public by registering information associated with itself in the web3ai contract (310) so that anyone can verify the web3ai agent (100) through the web3ai contract (310). When the web3ai agent (100) transmits an information registration request including information to be registered and an electronic signature generated based on the private key corresponding to the web3ai-ID to the blockchain network (300), the information may be registered in the web3ai contract (310) corresponding to the web3ai-ID.

Existing smart contract technology is limited to registering smart contract interfaces and operation codes in blockchain networks and enabling their execution. The web3ai contract (310) according to an embodiment of the present invention extends existing smart contract technology to register a DID document (311), public certificates (312) issued for the web3ai-ID, off-chain AI agent service endpoint (313), off-chain AI agent service interface (314), on-chain AI agent TEE/ZK rollup contract (315), and on-chain smart contracts (316).

In various embodiments, the web3ai contract (310) enables verification of information associated with the web3ai agent (100) operating off-chain or operations performed by the web3ai agent (100) through the blockchain network (300). Hereinafter, off-chain may be understood as an expression referring to external networks other than on the blockchain network (300).

In various embodiments, data included in the items (311, 312, 313, 314, 315, 316) of the web3ai contract (310) may be registered or modified only by requests including an electronic signature generated based on the private key corresponding to the web3ai-ID of the web3ai agent (100). Therefore, only the web3ai agent (100), which is the owner of the web3ai-ID, has management authority over the web3ai contract (310).

The DID document (311) according to an embodiment may include information associated with the web3ai-ID. For example, a public key corresponding to the web3ai-ID may be stored in the DID document (311). The public key may be understood as a public key that may be controlled by the owner of the web3ai-ID. In various embodiments, a processor public key generated by the processor (110) of the web3ai agent (100) may be stored in the DID document (311).

The public certificates (312) according to an embodiment may be understood as a list of public certificates in VC (Verifiable Credentials) format, which is a web standard (W3C standard) specification issued for the web3ai-ID. The public certificates (312) of the web3ai contract (310) can be understood as a list of VCs published through the blockchain network (300) among VCs owned by the web3ai agent (100). The web3ai agent (100) may register VCs it wishes to make public among owned VCs in the public certificates (312) of the web3ai contract (310). The owner of the web3ai-ID may selectively publish information associated with the owner of the web3ai-ID through the public certificates (312) of the web3ai contract (310). For example, public certificates may include personal information (e.g., identity information) about the owner of the web3ai-ID issued by trusted institutions (e.g., government agencies, corporations, medical institutions, banks, etc.). In various embodiments, the trustworthiness of a web3ai-ID that owns many personal data in VC format issued by trusted institutions may be increased.

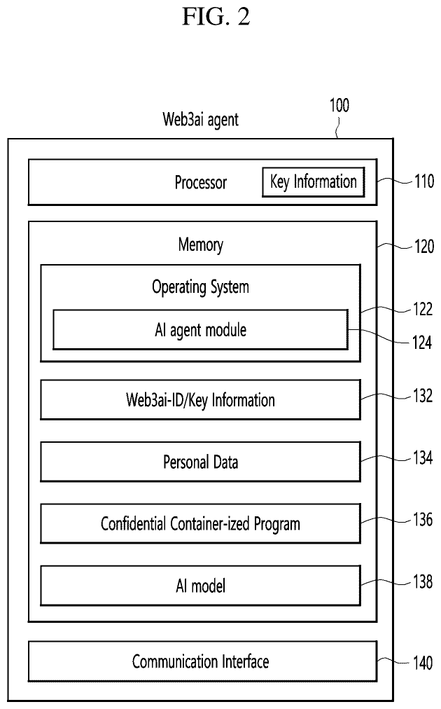

In various embodiments, at least some of the personal data stored by the web3ai agent (100) (e.g., personal data (134) in FIG. 2) may be managed in VC format. A VC includes the electronic signature of its issuer and the web3ai-ID of the owner. Therefore, the source of personal data (VC issuer and data creator) and the web3ai-ID (VC holder and data owner) can be bound. Personal data managed and processed in VC format cannot be forged or altered, and its source and owner may be verified through the blockchain network (300). In the protocol, since the identities of web3ai agents may be authenticated through the blockchain network (300) (e.g., through identity authentication VCs), users of web3ai agents may be safely protected from deep-fakes, spam, voice phishing, etc.

In various embodiments, the web3ai-ID owner may register only some of the VCs issued for the web3ai-ID in the public certificates (312) of the web3ai contract (310), and store the rest of the VCs in the web3ai agent (100). In some examples, VCs not published in the public certificates (312) may be provided directly to other web3ai agents when requested in the form of VP (Verifiable Presentation) including at least some information contained in the VC and an electronic signature generated based on the private key corresponding to the web3ai-ID.

The off-chain AI agent service endpoint (AI agent Service Endpoint (ASE), hereinafter ASE) (313) may be understood as information about where the web3ai agent (100) is being served. For example, the ASE (313) may include the URL of a mobile device (e.g., edge agent (10) in FIG. 2) or cloud server (e.g., cloud agent (20) in FIG. 2) implementing the AI agent services of the web3ai agent (100). Other web3ai agents may access the web3ai agent (100) through service endpoints registered in the ASE (313).

The off-chain AI agent service interface (AI agent Service Interface (ASI), hereinafter ASI) (314) is information about what service functions the web3ai agent (100) provides. The ASI (314) may include specifications of AI agent services being served off-chain. The web3ai agent (100) may register specifications for services it wishes to provide to other web3ai agents in the protocol in the ASI (314). The specification of AI agent services may include interface types as exemplified in Table 1.

TABLE 1
AI agent Service Interface Types

Natural Language Chat Interface
Audio/Video Call Interface)
RPC(Remote Procedure Call) Interface
Publish-Subscribe-Notify Interface

In various embodiments, the ASI (314) may include specifications published by other web3ai agents (e.g., web3ai agents (200, 400)). For example, when a second web3ai agent (200) publishes a specific AI agent service interface through a ASI of a second web3ai contract (320), the first web3ai agent (100) may import the published AI agent service interface of the second web3ai agent (200) into the ASI (314) of its first web3ai contract (310). In this manner, AI agent service interfaces published through web3ai contracts on the blockchain network (300) may be imported and reused by other web3ai agents.

In various embodiments, the plurality of web3ai agents (100, 200, 400) may autonomously utilize AI agent services published by different web3ai agents through ASEs and ASIs published on web3ai contracts (310, 320, 340) registered on the blockchain network (300), provide identical services through same interfaces, or implement various AI agent services for users by connecting AI agent services.

Through the DID document (311) and public certificates (312) registered in the web3ai contract (310), DID information and public identity information of the web3ai agent (100) may be published on the blockchain network (300). Accordingly, anyone may search for the web3ai agent (100) published based on the web3ai-ID and retrieve identity information of the web3ai agent (100). Additionally, anyone with access authority may call services provided by the web3ai agent (100) through the ASI (314) or perform communication with the web3ai agent (100).

According to an embodiment, implementations that operate various AI agent services provided through the ASI (314) (hereinafter, AI agent service implementations) may be included in an edge agent (10) and/or cloud agent (20) included in the web3ai agent (100). The on-chain AI agent TEE/ZK rollup contract (hereinafter, TEE/ZK rollup contract) (315) may include evidence data that may verify operations of AI agent service implementations executed off-chain. For example, evidence data regarding whether AI agent services are performed as published in the ASI (314) may be periodically registered in the TEE/ZK rollup contract (315).

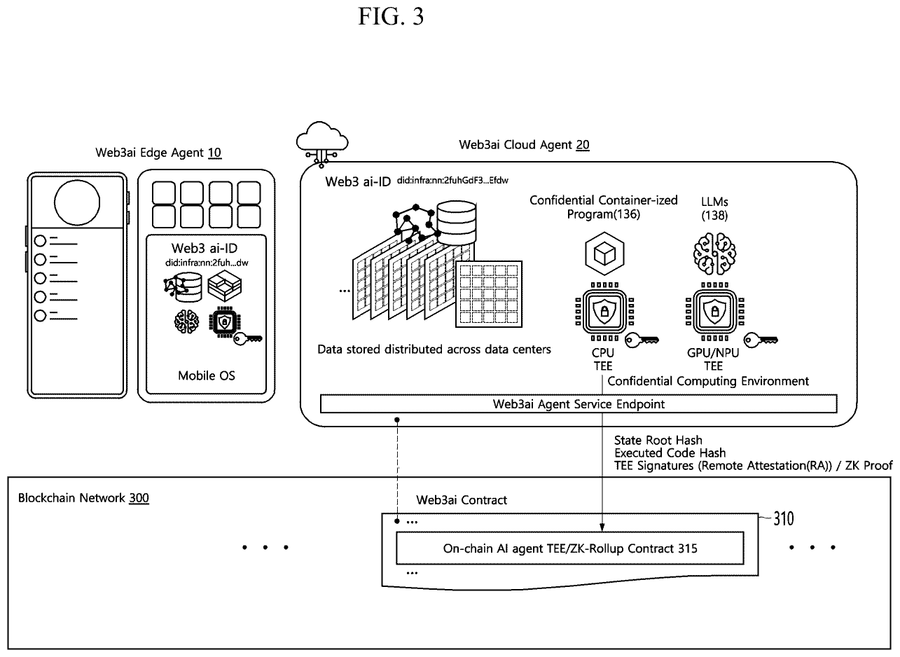

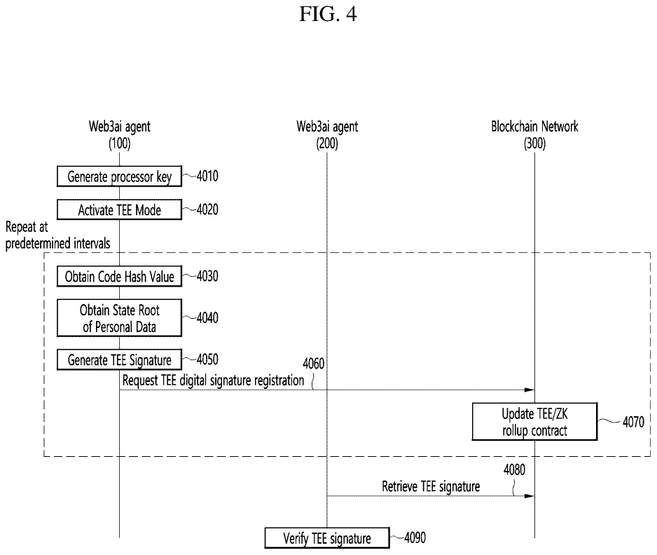

In various embodiments, since the web3ai agent (100) inevitably operates based on users' private data, it is necessary to ensure a confidential computing environment where private data is not exposed during such operation processes. The TEE/ZK rollup contract (315) may perform the role of ensuring this. For example, RA (Remote Attestation) electronic signatures enable verification of whether AI agent services operating off-chain were executed in TEE mode of a processor by confidential-containerized programs. ZK proofs enable verification of whether AI agent services were executed on zkVM. Detailed descriptions of this will be provided later through FIGS. 3 and 4.

The on-chain smart contract (316) may be understood as the functionality of existing smart contracts. The on-chain smart contract (316) may be understood as smart contract code deployed on the blockchain network (300). The on-chain smart contract (316) may support traditional smart contract technology that enables execution of functions such as token issuance or token trading (DEX) on the blockchain network (300). For example, AI agent services may be configured as paid models, and AI agent service usage fees may be settled through tokens on the blockchain network (300).

The protocol on which web3ai agents disclosed through the present invention operate is difficult to implement on existing Web 2.0 system ID systems. Existing ID systems may include, for example, ID/password ID systems stored/managed by central servers operated by for-profit companies (e.g., Google, Apple, Meta, OpenAI) as service providers, or ID systems such as OAuth-based SSO. If web3ai agents were implemented on Web 2.0 ID systems, ownership and control authority of individuals'/companies' web3ai agents would be transferred to specific companies' platforms. Therefore, private data necessary for web3ai agent operation would also be owned by specific companies, and risks of private data leakage by those companies' central servers would also exist.

Based on web3ai-ID and web3ai contract (310) according to an embodiment, a blockchain-based decentralized and verifiable computing environment may be created. In such an environment, an open AI agent ecosystem where the plurality of web3ai agents (100, 200, 400) may operate in interconnection with each other may be established. For example, when the plurality of web3ai agents (100, 200, 400) want to communicate with each other or use services published by others, they may first retrieve identity information (e.g., identity authentication VC) of web3ai agents registered in public certificates of web3ai contracts (310, 320, 340) on the blockchain network (300). Alternatively, when the plurality of web3ai agents (100, 200, 400) connect to specific web3ai agents, they may request identity information (e.g., identity authentication VC) directly from connected web3ai agents in real-time and perform identity verification. Through this, the plurality of web3ai agents (100, 200, 400) may perform data communication based on mutual trust relationships.

In various embodiments, web3ai agents may generate identical encryption keys through mutual key exchange (e.g., Diffie-Hellman key exchange) and perform secret communication using the encryption keys.

FIG. 2 is a block diagram of a web3ai agent (100) according to an embodiment. The web3ai agent (100) may include at least one processor (110), memory (120), and communication interface (140).

Referring to FIG. 1, the web3ai agent (100) may include an edge agent (10) and a cloud agent (20). The edge agent (10) may be understood as an agent operating on a mobile device such as a smartphone of a web3ai-ID owner (user). The cloud agent (20) may be understood as an agent operating on a cloud server accessible only by the web3ai-ID of the web3ai agent (100). The edge agent (10) and cloud agent (20) interconnect with each other through networks to operate as a single web3ai agent (100). The edge agent (10) and cloud agent (20) may each include the components of the web3ai agent (100) shown in FIG. 2.

The edge agent (10) according to various embodiments disclosed in this document may be various types of devices. The edge agent (10) may include, for example, portable communication devices (e.g., smartphones), computer devices, portable multimedia devices, portable medical devices, cameras, wearable devices, or home appliances. The edge agent (10) according to embodiments of this document is not limited to the aforementioned devices.

The processor (110) of the web3ai agent (100) may include at least one processor that controls operations of the web3ai agent (100). The processor (110) of the web3ai agent (100) may be operatively connected to the memory (120) and configured to execute instructions stored in the memory (120). In various embodiments, the processor (110) of the cloud agent (20) may include high-performance processors such as GPU and NPU.

In an embodiment, the processor (110) of the web3ai agent (100) may generate a pair of private key and public key (processor private key, processor public key) based on known encryption algorithms (e.g., RSA encryption algorithm) on a hardware security module (e.g., TEE (Trusted Execution Environment)) mounted on the processor (110). At this time, the processor private key may be stored in a security module within the processor (110), and the processor (110) may transmit the processor public key to outside the processor (110). The processor (110) may include a security module, and the processor private key may be stored in the security module ((e.g., Key information of the processor (110)).

In various embodiments, the processor public key transmitted outside the processor (110) may be stored in web3ai-ID/key information (132) of the web3ai agent (100), DID document (311) of the web3ai contract (310), and/or TEE/ZK rollup contract (315).

In various embodiments, the processor (110) may generate new processor keys (a pair of processor private key and processor public key) at predetermined intervals. When processor keys are changed, the changed processor public key may be additionally stored in web3ai-ID/key information (132), DID document (311) of the web3ai contract (310), and/or TEE/ZK rollup contract (315). Based on processor public keys published through the blockchain network (300), TEE electronic signatures may be verified.

The memory (120) of the web3ai agent (100) may include an operating system (122), web3ai-ID/key information (132), personal data (134), confidential containerized program (136), and AI model (138).

The operating system (122) may include an AI agent module (124). The AI agent module (124) may be understood as an artificial intelligence model implemented to autonomously control the web3ai agent (100) on behalf of users of the web3ai agent (100). The AI agent module (124) may be embedded in the operating system (122) and may control operations of the web3ai agent (100) (operations of the processor (110)) at the operating system level.

The web3ai-ID/key information (132) may include a web3ai-ID generated by the web3ai agent (100) and a pair of private key/public key corresponding to the web3ai-ID. In another example, when there are processor private key/public key generated by the processor (110), the web3ai-ID/key information (132) may store the processor public key.

The personal data (134) of the web3ai agent (100) may be understood as private information associated with the owner (user) of the web3ai-ID. The personal data (134) may be collected from the edge agent (10) or downloaded from third-party services. The personal data (134) may be generated based on data generated while the user uses the edge agent (10) or data generated while the user uses third-party services (e.g., SNS services, internet search services, etc.). The web3ai agent (100) may provide personalized responses to the user based on the personal data (134).

In various embodiments, the personal data (134) may include multiple data sets, and the multiple data sets may have a unified format. For example, the personal data (134) may be integrated and stored in verifiable PKG format.

In various embodiments, the personal data (134) may be stored in the edge agent (10) and cloud agent (20). The personal data (134) stored in the cloud agent (20) may have large capacity as massive data. The personal data (134) stored in the cloud agent (20) may be encrypted for security. For example, the personal data (134) may be encrypted based on private keys corresponding to web3ai-ID. The encrypted personal data (134) may be decomposed into multiple fragments and then distributed and stored in multiple data centers. Through this, the personal data (134) may be managed so as not to be dependent on a single cloud infrastructure service. When personal data (134) is encrypted using blockchain DID (web3ai-ID), only the owner of the web3ai-ID may access the data. Additionally, because it is encrypted, personal information leakage cannot occur while the personal data (134) is stored.

The confidential containerized program (136) may be understood as a program that operates in a confidential state to maintain data security. The confidential containerized program (136) may be understood as a program implemented to provide AI agent services. In various embodiments, the web3ai agent (100) may store AI agent service programs that operate based on personal data (134) in the form of confidential containerized program (136).

The AI model (138) may include at least one artificial intelligence model necessary for operations of personalized AI agents provided by the web3ai agent (100). For example, the AI model (138) of the edge agent (10) may be understood as an on-device AI model (e.g., SML). The AI model (138) of the cloud agent (20) may be understood as an AI model (e.g., LLM) that operates based on massive data.

The web3ai agent (100) may communicate with other web3ai agents and the blockchain network (300) through the communication interface (140). The edge agent (10) and cloud agent (20) are connected through the communication interface (140) and may operate as a single web3ai agent (100).

FIG. 3 is a diagram for explaining a method of preventing exposure of personal data processed on the web3ai agent (100) according to an embodiment. FIG. 4 is a signal flow diagram of a method for updating the TEE/ZK rollup contract (315) and verifying TEE electronic signatures according to an embodiment.

According to various embodiments, large amounts of personal data are required for the web3ai agent (100) to operate. Since all large-capacity data may not be stored and managed in the edge agent (10), almost all personal data (134) can be backed up in the cloud agent (20), and only frequently used data may be stored in the edge agent (10). Additionally, the cloud agent (20) is necessary to execute AI models such as LLMs that require high-performance computing resources (e.g., GPU, NPU, HBM) that are difficult to process with only on-device computing resources.

Particularly, since the cloud agent (20) operates on servers, when the cloud agent (20) processes personal data (134), the personal data (134) may be exposed in the server's memory. In this case, there is a possibility that personal data (134) may be leaked to cloud infrastructure providers (e.g., AWS, GCP, Azure). Hereinafter, referring to FIGS. 3 and 4, methods for preventing exposure of personal data when personal data is processed by the web3ai agent (100) (particularly, the cloud agent (20)) will be described.

In an embodiment, the processor (110) of the web3ai agent (100) may generate processor keys on a hardware security module mounted on the processor (110) (4010). The processor keys may include a pair of processor private key and processor public key. The processor private key may be stored within the processor (110), and the processor public key may be transmitted outside the processor (110).

The web3ai agent (100) may activate TEE mode (4020). For example, when operating programs that operate based on personal data (134), the web3ai agent (100) may activate TEE mode provided through the processor (110) of the web3ai agent (100).

For example, confidential computing may be performed based on TEE (Trusted Execution Environment), which is a hardware security module mounted on the processor (110) (e.g., CPU/GPU processor) of the cloud agent (20). TEE mode may be understood as a state in which the security module operates. Code executed and data processed in TEE mode of the processor (110) of the cloud agent (20) may be encrypted based on a process private key generated by the processor (110). Since code and data are processed in encrypted form on the memory (120), even operating systems (e.g., operating system (122)) with access to hardware memory on servers where the cloud agent (20) operates may not access the code and data in TEE mode.

In various embodiments, code of programs (e.g., confidential containerized program (136)) operated by the web3ai agent (100) may be published through open platforms, and interfaces of the code (programs) may be specified in the ASI (314). The published code may correspond to a single hash value. Hereinafter, a single hash value corresponding to published code is referred to as a code hash.

The web3ai agent (100) may execute code corresponding to at least one AI agent service specified in the web3ai contract and obtain a code hash value corresponding to the executed code (4030). The web3ai agent (100) may obtain a state root value for personal data processed through the executed code (4040). The web3ai agent (100) may generate an electronic signature (hereinafter, TEE electronic signature) for the code hash value and the state root value based on the processor private key (4050). The TEE electronic signature may be understood as an electronic signature capable of RA (Remote Attestation). When the cloud agent (20) is executed in TEE mode, electronic signatures for the hash value of currently executing code (code hash) and the state root value of personal data (e.g., personal data (134)) used in the code may be generated by the processor (110) of the cloud agent (20), i.e., the hardware itself.

The web3ai agent (100) may transmit a TEE electronic signature registration request to the blockchain network (300) (4060). The TEE electronic signature registration request may include web3ai-ID, processor public key, TEE electronic signature, and electronic signature generated by private key corresponding to web3ai-ID. The TEE electronic signature and processor public key may be registered in the TEE/ZK rollup contract (315) of the web3ai contract (310) of the web3ai agent (100) (4070). While TEE mode is activated, the web3ai agent (100) may generate TEE electronic signatures at predetermined intervals through operations 4030 to 4070 and transmit TEE electronic signature registration requests for the generated TEE electronic signatures to the blockchain network (300). Accordingly, new TEE electronic signatures may be registered in the TEE/ZK rollup contract (315) at predetermined intervals.

Since TEE electronic signatures are electronic signatures for code hashes of personal information processing programs executed in TEE mode and state root values of personal data, it becomes possible to know which programs were executed through the code hash values. Additionally, since state root values of personal data change as code is executed, multiple TEE electronic signatures registered in the TEE/ZK rollup contract (315) prove that when specific published code is executed, the code and personal data were executed in TEE mode without exposure.

In various embodiments, even when the web3ai agent (100) executes specific code through external cloud server equipment, it can be guaranteed that published code was safely executed without personal information leakage through TEE electronic signatures registered in the TEE/ZK rollup contract (315). Additionally, since TEE electronic signatures are published on the blockchain network (300), anyone can verify TEE electronic signatures.

For example, when a second web3ai agent (200) wants to verify TEE electronic signatures of a first web3ai agent (100), the second web3ai agent (200) may retrieve TEE electronic signatures and processor public keys registered in the TEE/ZK rollup contract (315) of the first web3ai agent (100) (4080). The second web3ai agent (200) may verify which manufacturer's processor generated the processor public key through predetermined methods provided by processor manufacturers (e.g., NVIDIA, Intel). Additionally, code hash value that was the basis of the TEE electronic signatures may be obtained through the processor public key. Meanwhile, since code corresponding to the code hash value is published through open platforms, the second web3ai agent (200) may identify which code was executed by the first web3ai agent (100).

In various embodiments, TEE electronic signatures may be verified by contract code. For example, the TEE/ZK rollup contract (315) may be written to enable verification of TEE electronic signature registration requests from the web3ai agent (100) on the blockchain network (300). When TEE electronic signature verification processes (e.g., operation 4090) are performed on the TEE/ZK rollup contract (315), the blockchain network (300) may register only verified TEE electronic signatures in the TEE/ZK rollup contract (315) and reject TEE electronic signature registration requests when verification fails. When the TEE/ZK rollup contract (315) is implemented to perform TEE electronic signature verification, simply confirming that TEE electronic signatures are registered in the TEE/ZK rollup contract (315) may prove that the web3ai agent (100) operates without exposure of personal data.

In various embodiments, AI agent services that are published as open source and have no personal information leakage may be virtualized through confidential container technology and executed in TEE mode of CPUs of the cloud agent (20). Published AI models may be executed through TEE mode provided by GPUs of the cloud agent (20) in ways that eliminate possibilities of leakage of personal data used in AI model training and inference.

In another example, AI agent services of the web3ai agent (100) may be implemented on layer 2 blockchain networks operating based on layer 1 blockchain networks (e.g., blockchain network (300)). For example, AI agent services may be implemented on zkEVM (zero-knowledge Ethereum Virtual Machine) or RISC-V instruction set-based zkVM (zero-knowledge Virtual Machine). In this case, the web3ai agent (100) may generate Zero-Knowledge Proofs that publicly authenticated code was well executed without exposure of processed personal data. And the web3ai agent (100) may periodically register the generated zero-knowledge proofs in the TEE/ZK rollup contract (315) of the web3ai contract (310) corresponding to the layer 1 blockchain network (300). Additionally, since such zero-knowledge proofs are published on the blockchain network (300), anyone may verify them.

The TEE/ZK rollup contract (315) of the web3ai contract (310) may guarantee that AI agent services are being executed without leakage of private data by using TEE technology of processor hardware, and ZK technology-based virtual machines (VMs).

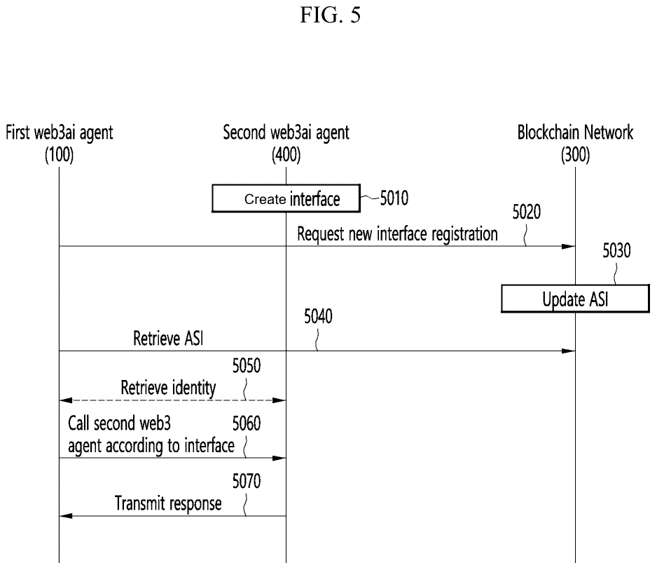

FIG. 5 is a signal flow diagram of a method for creating and utilizing AI agent service interfaces on a protocol according to an embodiment. For example, it is assumed that the first web3ai agent (100) is a personally owned personal agent, and the second web3ai agent (400) is a company-owned service agent.

The second web3ai agent (400) may create an interface for AI agent services (5010) and transmit a registration request for the interface to the blockchain network (300) (5020). The registration request for the interface may include an interface to be registered, a second web3ai-ID of the second web3ai agent (400), and an electronic signature generated based on a private key corresponding to the second web3ai-ID. The blockchain network (300) may verify the second web3ai-ID that sent the registration request based on the electronic signature and register the interface in the ASI of the second web3ai contract (340) of the second web3ai agent (400) (5030).

The first web3ai agent (100) may retrieve an interface of AI agent services provided by the second web3ai agent (400) through the blockchain network (300) (ASI of the second web3ai contract (340)) (5030). The first web3ai agent (100) may retrieve the ASI of the second web3ai contract (340) based on the second web3ai-ID of the second web3ai agent (400) and select an interface to use (5040).

The first web3ai agent (100) may call the second web3ai agent (400) according to the selected interface (5060). The first web3ai agent (100) may receive a response to the call from the second web3ai agent (400) (5070). The first web3ai agent (100) may determine at least one parameter included in the selected interface. The first web3ai agent (100) may call the second web3ai agent (400) based on the determined parameter. The first web3ai agent (100) may retrieve an ASE included in the second web3ai contract (340) of the second web3ai agent (400) and call the second web3ai agent (400) based on the obtained service endpoint.

AI agent services according to various embodiments may be services that provide personalized services based on personal data. When performing a call to use AI agent services in operation 5060, the first web3ai agent (100) may transmit personal data as parameters. The first web3ai agent (100) may call the second web3ai agent (400) based on at least one parameter determined based on personal data (134).

In various embodiments, the first web3ai agent (100) and the second web3ai agent (400) may perform mutual identity verification (5050). For example, the first web3ai agent (100) may retrieve identity information of the second web3ai agent (400) before calling the second web3ai agent (400). For example, the first web3ai agent (100) may retrieve identity authentication VCs published through public certificates of the second web3ai contract (340). The first web3ai agent (100) may retrieve identity information of the second web3ai agent (400) (e.g., information about individuals or companies that own and operate the second web3ai agent (400)) through the identity authentication VC. The first web3ai agent (100) may call the second web3ai agent (400) only when the second web3ai agent (400) may be trusted through the identity authentication VC (5060).

Additionally, when the second web3ai agent (400) receives a call request according to operation 5050, the second web3ai agent (400) may retrieve identity information to verify whether the first web3ai agent (100) is a user with authority for the call (e.g., a user who paid fees). For example, the second web3ai agent (400) may retrieve identity authentication VCs published through public certificates (312) of the first web3ai contract (310). Only when the first web3ai agent (100) has such authority as a result of identity information retrieval, the second web3ai agent (400) may transmit a response according to operation 5060.

In various embodiments, the operations of FIG. 5 may be equally applied when the second web3ai agent (400) calls the first web3ai agent (100). When the first web3ai agent (100) receives a call according to an interface specified in the first web3ai contract (310) (ASI (314)) from the second web3ai agent (400) (5060), the first web3ai agent (100) may verify whether the second web3ai agent (400) has authority for the call based on identity authentication VCs of the second web3ai agent (400) included in the second web3ai contract (340) of the second web3ai agent (400) registered on the blockchain network (300) (5050). When authority for the call is verified, the first web3ai agent (100) may execute the code corresponding to the call. The first web3ai agent (100) may generate a response to the call based on results generated by code execution and transmit the generated response to the second web3ai agent (400) (5070). The first web3ai agent (100) may execute the code corresponding to the call based on parameters determined based on personal data of the second web3ai agent (400).

In various embodiments, the first web3ai agent (100) may obtain the identity information by retrieving the identity authentication VC registered in a second web3ai contract corresponding to the second web3ai agent (400)/second web3ai-ID. Alternatively, the first web3ai agent (100) may transmit an identity information request to the second web3ai agent (400) and obtain the identity information from the identity authentication VP received from the second web3ai agent (400) according to the request. The second web3ai agent (400) may generate an identity authentication VP based on identity authentication VCs stored in the second web3ai agent (400) and transmit the generated identity authentication VP to the first web3ai agent (100). The identity authentication VP may include the second web3ai-ID, an electronic signature generated based on a private key corresponding to the second web3ai-ID, an electronic signature of the creator of the identity authentication VC, and identity information requested by the first web3ai agent (100).

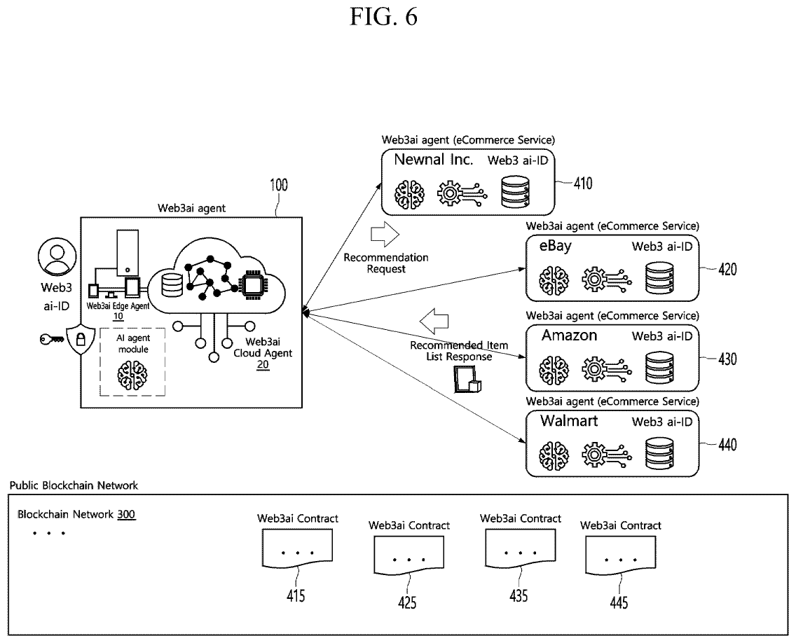

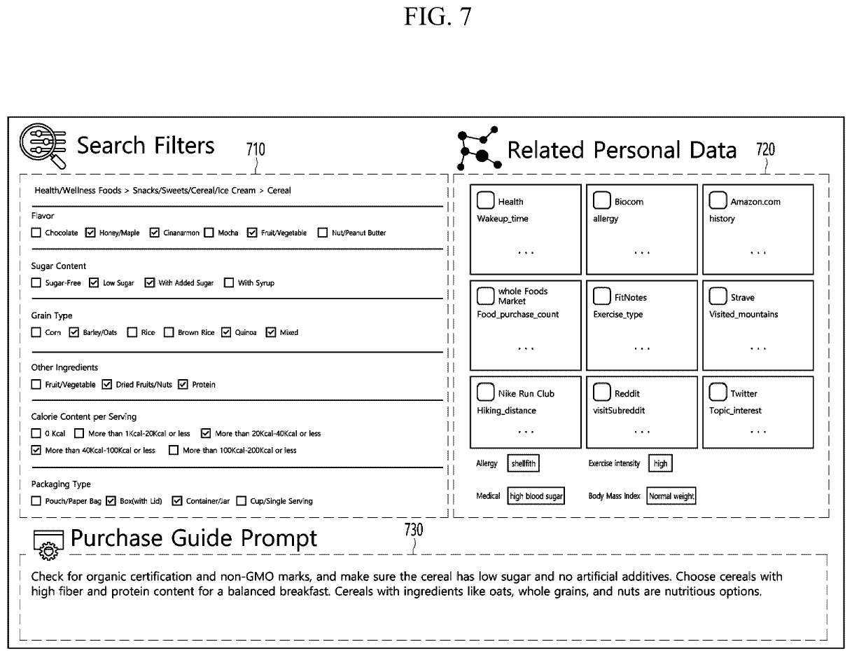

FIG. 6 is an example of item recommendation services provided by a plurality of e-commerce service web3ai agents (410, 420, 430, 440) according to an embodiment. FIG. 7 is an example of an interface for item recommendation services associated with e-commerce services.

In various embodiments, the web3ai agent (100) may process item purchases on behalf of web3ai-ID owners (users). The web3ai agent (100) may communicate with a plurality of e-commerce service web3ai agents (410, 420, 430, 440) to purchase items when there are user requests or when the web3ai agent (100) determine that some items are needed for the user. During this communication process, item search and purchase may be processed.

The web3ai agent (100) may search for web3ai agents operated by e-commerce service providers among web3ai agents published on the blockchain network (300).

The web3ai agent (100) may identify interfaces of AI agent service for item recommendation (hereinafter, item recommendation services) based on ASIs (e.g., ASI (314) in FIG. 1) through web3ai contracts (415, 425, 435, 445) (e.g., web3ai contract (310) in FIG. 1) of the e-commerce service web3ai agents (410, 420, 430, 440). The web3ai agent (100) may receive recommended item lists from the e-commerce service web3ai agents (410, 420, 430, 440) based on interfaces of the identified item recommendation services.

Referring to FIG. 7, the interface (700) of item recommendation services may include parameters of search filters (710), related personal data (720), and purchase guide prompt (730). The interface (700) is an example of parameters determined to receive recommendations for cereal bars for a user's breakfast.

The web3ai agent (100) may automatically set search filters (710) suitable for users based on personal data of web3ai-ID owners (users). For example, search filters (710) may be set based on users' previous order history, allergy information, preferred tastes, etc., included in personal data (134).

The web3ai agent (100) may extract related personal data (720) necessary for item recommendations from personal data (134). For example, the web3ai agent (100) may configure related personal data (720) based on user data obtained from related applications (e.g., health, bio, e-commerce, SNS, etc.) and users' health information (e.g., allergies, diseases, etc.).

Additionally, the web3ai agent (100) may write purchase guide prompt (730) based on personal data (134). For example, purchase guide prompt (730) may be written by the AI agent module (124) based on information about users' preferred tastes and preferred foods stored in personal data (134).

The web3ai agent (100) may call e-commerce service web3ai agents (410, 420, 430, 440) based on the determined search filters (710), related personal data (720), and purchase guide prompt (730). The web3ai agent (100) may call e-commerce service web3ai agents (410, 420, 430, 440) by transmitting item recommendation requests including the determined parameters (search filters (710), related personal data (720), and purchase guide prompt (730)) to the e-commerce service web3ai agents (410, 420, 430, 440) (e.g., operation 5060 in FIG. 5).

The e-commerce service web3ai agents (410, 420, 430, 440) may select the most suitable items based on search filters (710), related personal data (720), and purchase guide prompt (730) transmitted from the web3ai agent (100), and transmit recommended item lists including the selected items to the web3ai agent (100) (e.g., operation 5070 in FIG. 5). For example, the service web3ai agents (410, 420, 430, 440) may execute AI-based recommendation modules (e.g., AI model (138)) to select suitable items and generate recommended item lists.

When the web3ai agent (100) receives the recommended item list, the web3ai agent (100) may compare items included in the list and perform purchases of an item. For example, the web3ai agent (100) may select N items from the recommended item list and provide the N item list to users. When the web3ai agent (100) receives selection input for an item from the N item list, the web3ai agent (100) may perform a purchase of the selected item.

As shown through FIGS. 6 and 7, the web3ai agent (100) may process an item purchase by directly communicating with web3ai agents (410, 420, 430, 440) operated by e-commerce service providers, rather than through applications created by e-commerce service providers (appless process). Through the appless process, web3ai-ID owners (users) may conveniently purchase items by receiving recommendations based on search results through multiple e-commerce applications without needing to directly search for items using multiple e-commerce applications.

In this way, web3ai agents may perform autonomous interactions through blockchain-based web3ai-ID and web3ai contract protocols. Through this, tasks may be performed through automatic activities of web3ai agents without users directly using apps.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar or related reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). When a component (e.g., a first component) is referred to as being “coupled” or “connected” to another component (e.g., a second component), with or without the terms “functionally” or “communicatively,” it means that the component can be connected to the other component directly (e.g., wired), wirelessly, or through a third component.

The term “module” used in this document may include a unit implemented as hardware, software, or firmware, and may be used interchangeably with terms such as logic, logic blocks, components, or circuits. A module may be an integrally configured component or a minimum unit of such component or a part thereof that performs one or more functions. For example, according to an embodiment, a module may be implemented in the form of an ASIC (application-specific integrated circuit).

Various embodiments as set forth herein may be implemented as software including one or more instructions that are stored in a storage medium (e.g., the memory 120) that is readable by web3ai agent (100). For example, a processor (e.g., the processor 110) of the web3ai agent (100) may invoke at least one of the one or more instructions stored in the storage medium, and execute the invoked instruction. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method according to various embodiments disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single subject or multiple subjects. According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as those performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A first web3ai agent, comprising:
a memory storing a first web3ai-ID corresponding to the first web3ai agent and a private key corresponding to the first web3ai-ID;
a communication interface configured to communicate with a blockchain network on which a first web3ai contract corresponding to the first web3ai agent is registered; and
at least one processor,
wherein the at least one processor is configured to:
generate a pair of a processor private key and a processor public key,
transmit the processor public key to an outside of the at least one processor,
execute code corresponding to at least one AI agent service specified in the first web3ai contract,
obtain a code hash value corresponding to the executed code,
obtain a state root value for personal data processed through the executed code,
generate a first electronic signature for the code hash value and the state root value based on the processor private key, and
transmit, to the blockchain network, a registration request for the first electronic signature including a second electronic signature generated based on the first electronic signature and the private key corresponding to the first web3ai-ID to register the first electronic signature in the first web3ai contract.

2. The first web3ai agent of claim 1, wherein the at least one processor is configured to:
generate the first electronic signature at predetermined intervals, and
transmit the registration request for the generated first electronic signature to the blockchain network.

3. The first web3ai agent of claim 1, wherein the at least one processor is configured to:
generate the web3ai-ID and a pair of the private key and a public key corresponding to the web3ai-ID, and
transmit, to the blockchain network, a creation request for a web3ai contract including the web3ai-ID and an electronic signature generated based on the private key,
wherein the web3ai contract is created on the blockchain network corresponding to the web3ai-ID.

4. The first web3ai agent of claim 1, wherein the at least one processor is configured to:
retrieve an identity authentication VC of a second web3ai agent included in a second web3ai contract registered on the blockchain network to communicate with the second web3ai agent,
call the second web3ai agent according to an interface specified in the second web3ai contract, and
receive a response to the call from the second web3ai agent.

5. The first web3ai agent of claim 4, wherein:
the memory stores personal data, and
the at least one processor is configured to:
determine at least one parameter included in the interface based on the personal data, and
call the second web3ai agent based on the generated at least one parameter.

6. The first web3ai agent of claim 1, wherein the at least one processor is configured to:
when receiving a call from a second web3ai agent according to an interface specified in the first web3ai contract, verify whether the second web3ai agent has authority for the call based on identity information of the second web3ai agent and
execute the code corresponding to the call.

7. The first web3ai agent of claim 6, wherein the at least one processor is configured to:
execute the code corresponding to the call based on a parameter determined based on personal data of the second web3ai agent.

8. The first web3ai agent of claim 6, wherein the at least one processor is configured to:
obtain the identity information by retrieving an identity authentication VC registered in a second web3ai contract corresponding to the second web3ai agent, or transmit an identity information request to the second web3ai agent and obtain the identity information from an identity authentication VP received according to the request.
